(19) United States
(12) Patent Application Publication
(10) Pub. No.: US 2025/0269728 A1
(43) Pub. Date: Aug. 28, 2025

(54) WHEEL RAILWAY SYSTEM WITH AUXILIARY PROPULSION SYSTEM

(71) Applicant: NEVOMO POLAND SP. Z O.O., Warsaw (PL)

(72) Inventors: Pawel Radziszewski, Warsaw (PL); Kacper Koniarski, Warsaw (PL); Aleksander Hernik, Jedlnia Letnisko (PL)

(73) Assignee: NEVOMO POLAND SP. Z O.O., Warsaw (PL)

(21) Appl. No.: 18/858,381

(22) PCT Filed: Apr. 13, 2023
(86) PCT No.: PCT/EP2023/059621

§ 371 Date: Oct. 21, 2024

(30) Foreign Application Priority Data
Apr. 22, 2022 (EP) 22169563.8

(51) Int. Cl. B60L 13/03; B60L 13/00; B60L 15/32; B61B 13/08; B61C 15/06; B61L 25/02

(52) U.S. Cl. CPC B60L 13/03; B60L 13/003; B60L 15/32; B61C 15/06; B61L 25/025; B61B 13/08

(57) ABSTRACT

Railway system with a railway infrastructure including a wheel railway track and wheel railway vehicles driven on the wheel railway track, the wheel railway track including rails mounted on a ballasted or unballasted ground support, for instance provided with sleepers, the wheel railway vehicles comprising a chassis and wheels coupled to the chassis, and a propulsion system, wherein the propulsion system comprises a retrofitted linear electric motor, the linear electric motor comprising a mover mounted on an underside of the chassis, or mounted on an underside of one or more bogies comprising said wheels, and a stator comprising an electromagnetic drive mounted along at least a section of the wheel railway track between the rails of the wheel railway track.

The present invention relates to a wheel railway system with an improved propulsion system.

A large proportion of existing railway infrastructure is based on conventional railway tracks and railway vehicles with wheels propelled by a diesel motor or an electric rotary motor mounted on board one or more locomotives that pull or push carriages for the transport of persons or cargo.

The existing railway infrastructure is shared by vehicles that transport persons and vehicles that transport cargo. The use of a common infrastructure between passenger and cargo trains needs to be coordinated. Cargo trains however are typically heavier than passenger trains and thus travel at slower speeds especially when ascending an inclined section of railway track. A further time consuming operation involves the loading and unloading of cargo on railway vehicles, such loading operations typically being performed in shunting yards. For instance, with cargo containers transported on road by trucks, the container is typically removed from the track and placed on a shunting vehicle that displaces the container to the railway transport vehicle for loading on the railway transport vehicle. The shunting vehicle thus acts as an interface between the road truck and the cargo train set. In view of the cost of railway infrastructure and the constraints regarding the use of land for new infrastructure, it is desirable to optimize the use of existing infrastructure in order to increase the transport of persons and goods. Moreover, such optimization should take into account the railway infrastructure standards already in place.

In view of the foregoing, it is an object of this invention to provide a wheel railway system compatible with existing infrastructure that is optimized to increase speeds and/or density of the transport of persons and cargo compared to the existing situation.

It is advantageous to provide an improved railway system that allows retrofitting on existing vehicles and railway track infrastructure in an economical and rapid manner.

It is advantageous to provide an improved wheel railway system having a high reliability and safety.

It is advantageous to provide a wheel railway system that may be easily implemented in railway infrastructure with different standards such as found across the European continent and that can be deployed easily, economically and rapidly.

Objects of the invention have been achieved by providing a railway system according to claim 1.

Dependent claims set forth various advantageous embodiments of the invention.

Disclosed herein is a railway system with a railway infrastructure including a wheel railway track and wheel railway vehicles driven on the wheel railway track, the wheel railway track including rails mounted on a ballasted or unballasted ground support, for instance provided with sleepers, the wheel railway vehicles comprising a chassis, wheels coupled to the chassis, and a propulsion system including a retrofitted linear electric motor, the linear electric motor comprising a mover mounted on an underside of the chassis, or mounted on an underside of one or more bogies comprising said wheels, and a stator comprising an electromagnetic drive mounted along at least a section of the wheel railway track between the rails of the wheel railway track.

According to a first aspect, the mover coupling mechanism includes a propulsion direction adjustment mechanism configured to adjust a position of the permanent magnet unit with respect to the chassis or bogie in a direction of propulsion of the vehicle.

According to a second aspect, the propulsion system comprises a motor control system including an electronic control unit and a wheel rotation sensor coupled to the wheels to measure a speed of the rotation of the wheel, the motor control system further comprising a wireless communication system including a vehicle antenna configured to communicate wirelessly to external control systems coupled to track side antennas. The communications system and control system may be configured to allow a plurality of vehicles to be driven in a platoon formation where the position of the vehicles is provided by the coupling of the movers to the stator for each vehicle.

In an advantageous embodiment, at least one of the wheel railway vehicles is a railway locomotive comprising a dual propulsion system, including the linear electric motor and a wheel rotation drive coupled via a transmission to at least one pair of the wheels of the railway vehicle.

In an advantageous embodiment, the linear electric motor is configured as an auxiliary power unit that supplements the power provided by the wheel rotation drive, for instance during acceleration of the railway vehicle or to maintain a constant speed when ascending an inclined section of railway track.

In an advantageous embodiment, the mover of the linear electric motor comprises a permanent magnet unit and a mover coupling mechanism including a height adjustment mechanism configured to adjust a height of the permanent magnet unit with respect to the chassis or bogie so as to adjust an airgap between the permanent magnet unit and the electromagnetic drive of the stator.

In an advantageous embodiment, the height adjustment mechanism of the mover coupling mechanism comprises an actuator and a slide, the actuator including a linear ball screw actuator.

In an advantageous embodiment, the slide comprises a ball or roller bearing slide.

In an advantageous embodiment, the propulsion direction adjustment mechanism of the mover coupling mechanism comprises an actuator and a slide, the actuator including a linear ball screw actuator.

In an advantageous embodiment, the slide comprises a ball or roller bearing slide.

In an advantageous embodiment, the linear electric motor measures a position of the vehicle along the stator and the motor control system comprises a module translating the position information into a standard transponder code.

In an advantageous embodiment, the stator of the linear electric motor comprises a coupling mechanism interconnecting the electromagnetic drive to a ballast support member, the coupling mechanism having a height adjustment mechanism configured to adjust the height of the electromagnetic drive with respect to the rails on the railway track.

In an advantageous embodiment, a switch mechanism of the railway system comprises switch rods, guardrails and closure rails of non-ferromagnetic alloys.

In an advantageous embodiment, the motor control system comprises a communication system configured to perform both vehicle-to-vehicle and vehicle to infrastructure.

Further objects and advantageous features of the invention will be apparent from the claims, from the detailed description, and annexed drawings, in which:

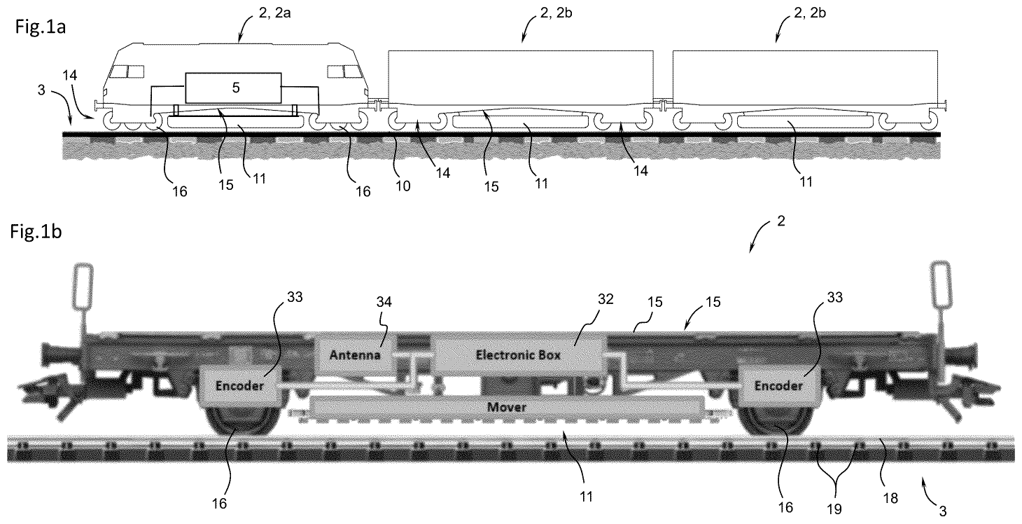

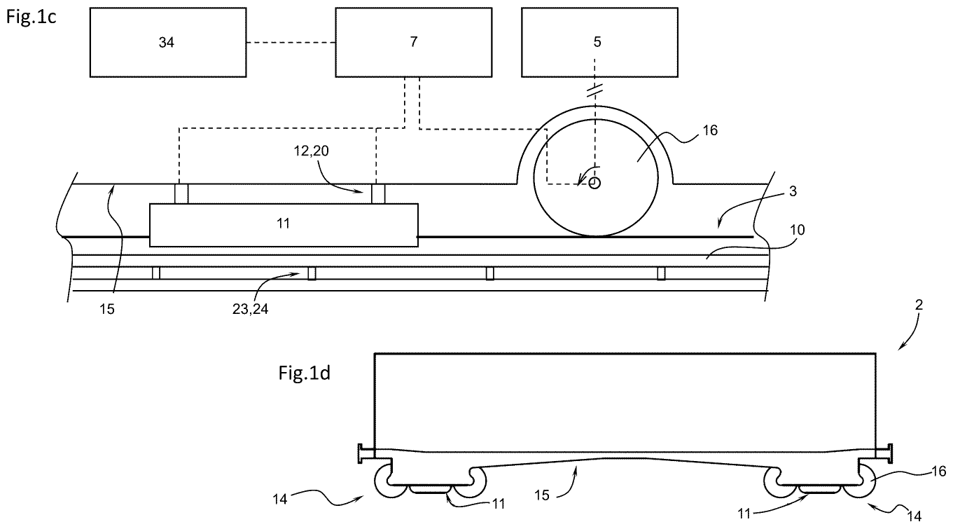

FIG. 1a is a schematic representation of a railway train set of a railway system according to an embodiment of the invention;

FIG. 1b is a schematic representation of a railway vehicle of a railway system according to an embodiment of the invention;

FIG. 1c is a schematic representation of a portion of a railway vehicle of a railway system according to an embodiment of the invention;

FIG. 1d is a schematic representation of a railway vehicle of a railway system according to an embodiment of the invention;

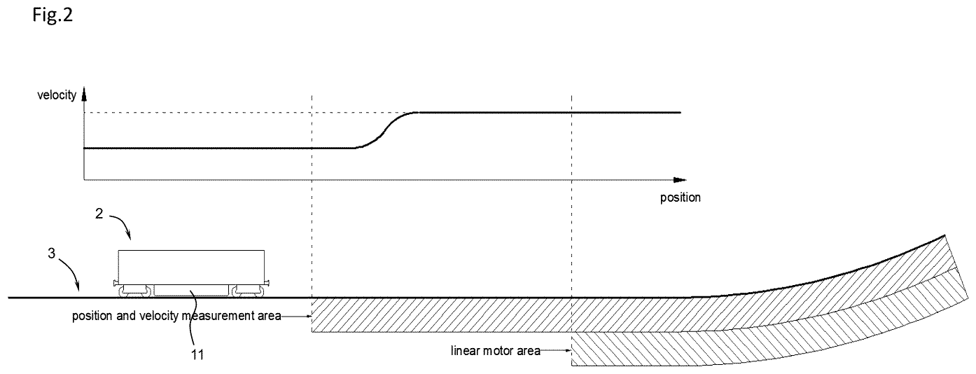

FIG. 2 is a schematic representation of a railway vehicle on a railway track having an inclined section according to an embodiment of this invention;

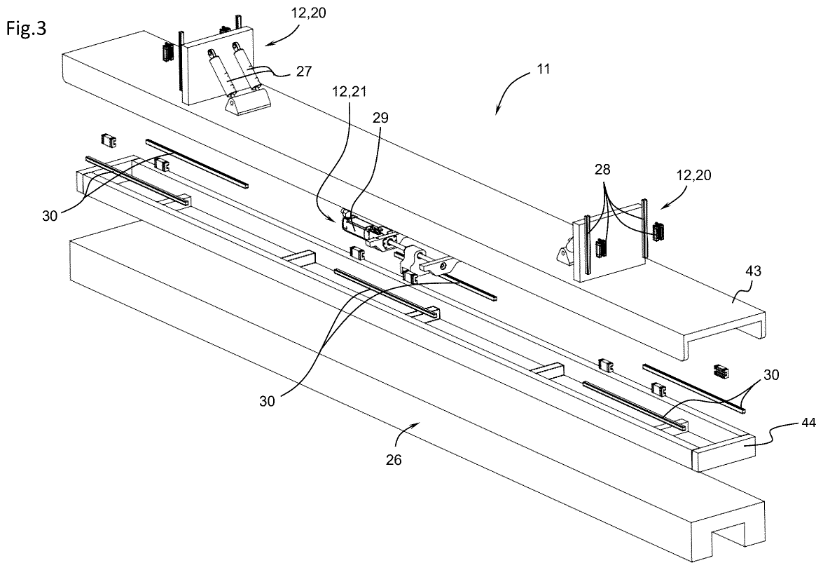

FIG. 3 is a schematic perspective exploded view of a mover of a linear electric motor of a railway system according to an embodiment of this invention;

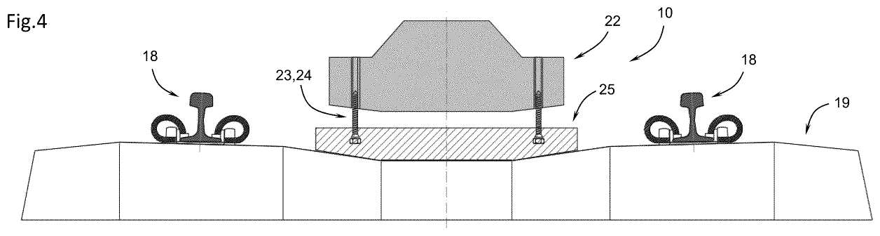

FIG. 4 is a cross-sectional view of a wheel railway track and a stator of a linear electric motor of a railway system according to an embodiment of this invention;

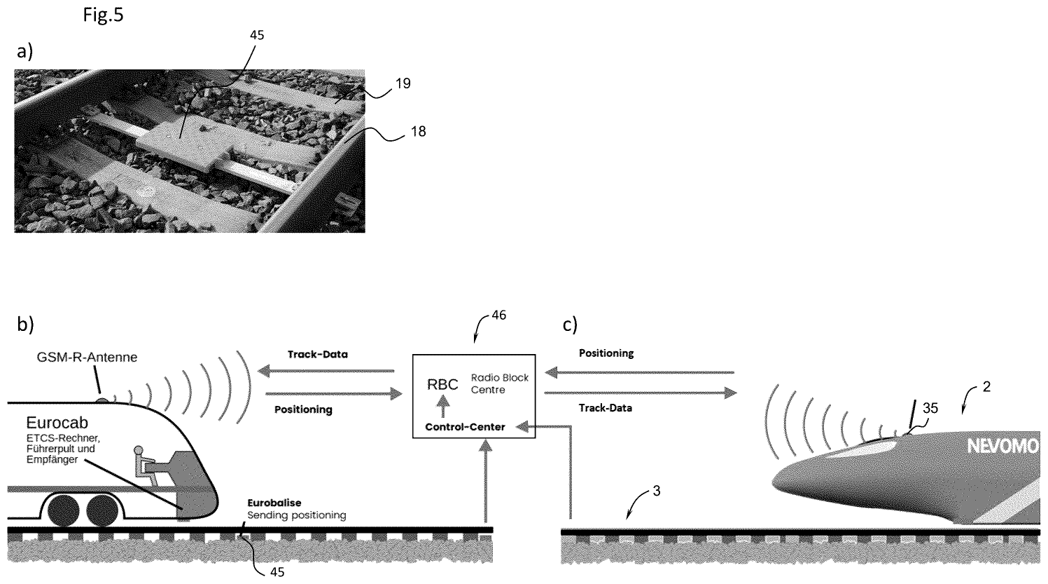

FIG. 5 illustrates schematically a railway system with a transponder (beacon), FIG. 5a illustrating a photograph of a standard Eurobalise transponder mounted on railway track, FIG. 5b illustrating a conventional railway vehicle approaching a Eurobalise, FIG. 5c illustrating a railway track of a railway system according to an embodiment of this invention transmitting information according to a standard Radio Block Centre using position information from a linear electric motor according to an embodiment of the invention;

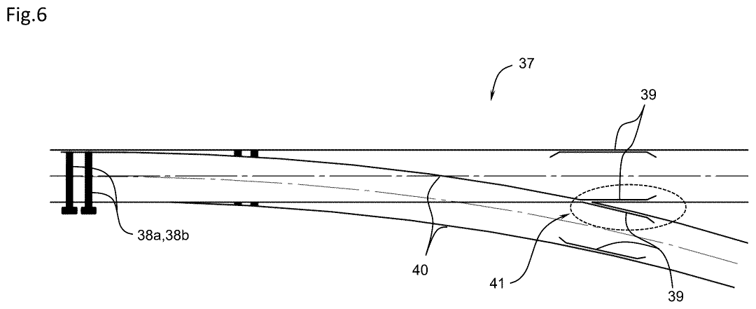

FIG. 6 is a schematic representation overhead of a section of track with a switch;

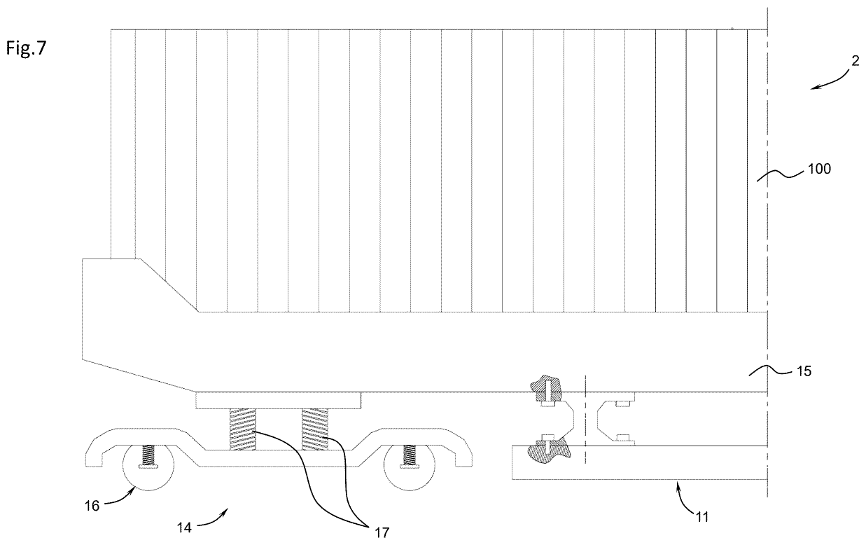

FIG. 7 is a schematic side view of a portion of a shunting railway vehicle according to an embodiment of the invention.

Referring to the figures, a railway system 1 according to embodiments of the invention comprises a wheel railway vehicle 2 comprising a chassis or platform 15 coupled to wheels 16 that roll on conventional rails 18 of a wheel railway track 3. The wheels may be provided on one or more bogies 14.

The wheel railway vehicle 2 may comprise a carriage 13 mounted on the chassis or platform 15, the carriage for housing locomotive components of a railway vehicle, or for the transport of persons or cargo. Certain railway vehicles may also be provided without a carriage, adapted for receiving a cargo vessel or container thereon.

The railway vehicles may be adapted for individual locomotion along a vehicle railway track or may be adapted for coupling to other vehicles to form a train set comprising a plurality of vehicles 2 as illustrated in FIG. 1a. In the scope of the invention, one or more of the vehicles may serve as locomotive vehicle 2a providing the propulsion or traction force and other vehicles 2b of the train set may be provided without any propulsion or traction means. However, within the scope of the invention each of the vehicles coupled together to form a train set may comprise a propulsion system. The propulsion systems of a plurality of vehicles in a train set may be in use simultaneously, or certain of the propulsion systems may be switched off during a portion or an entire section of a voyage between a departure station and a destination station.

The wheels 16 are typically coupled to a platform or chassis 15 via a suspension as per se well known.

Within the scope of the invention, certain vehicles of the railway system 1 may serve as shunting vehicles for interfacing between a road truck and cargo wheel railway train set, or between two wheel railway train sets, for instance for use in a shunting station of a railway system.

According to an aspect of the invention, the wheel railway vehicle 2 comprises a propulsion system 4 that includes a linear electric motor 6 having a mover 11 assembled to an underside of the chassis 15 or bogie 14, positioned between the wheels 16 on opposite sides of the railway vehicle, and therefore between the rails of the railway track. The mover may be positioned between bogies 14 as illustrated in FIGS. 1a, 1b, or within one or more of the bogies 14 of the railway vehicle 2 as illustrated in FIG. 1d.

The wheel railway vehicle 2 may further comprise a propulsion system including a wheel rotation drive 5.

Said wheel railway vehicle may be in the form of a conventional railway locomotive retrofitted with said linear electric motor 6. Existing railway vehicles and in particular railway vehicle locomotives may thus be retrofitted with a linear electric motor to provide auxiliary power. The linear electric motor may however be fitted to an underside of a railway vehicle that does not comprise a wheel rotation drive 5, for instance a conventional railway vehicle that does not serve as a locomotive in conventional use but that is retrofitted with a linear electric motor to render the vehicle capable of being displaced individually, or as part of a train set to provide additional propulsion force. Independent displacement of individual non-locomotive carriages may also serve to compose train sets and manage the storage of carriages in a shunting yard.

The auxiliary additional propulsion force of the electric linear motor(s) may be provided continuously, or occasionally when needed depending on the requirements and the conditions affecting the train speed such as the weight, angle of inclination of the track, or desired rate of acceleration.

The conventional part of the locomotive may be an electrical vehicle comprising a pantograph 31 that connects to a catenary, for instance overhead the railway system as is well known. The conventional part of the locomotive however may also be driven by autonomous power means such as a diesel engine onboard the locomotive.

A locomotive vehicle 2a according to an embodiment of this invention thus comprises a dual propulsion system including the wheel rotation drive 5 supplemented with the linear electric motor 6. The locomotive may thus drive along a section of track that does not comprise an electric motor stator, and therefore travel along existing unmodified railway track infrastructure, and for sections of railway track provided with a stator 10 of the linear electric motor, to be provided with additional auxiliary power, or alternatively to be driven only by the linear electric motor with the rotary drive 5 being switched off. Increased versatility over existing systems may thus be achieved with such a system.

The linear electric motor according to an embodiment of the invention comprises a mover 11, as mentioned above, fitted on an underside of the chassis 15 or bogie 14 of a railway vehicle 2, positioned between the wheels and substantially overhead a center of the wheel railway track 3. The mover 11 that couples electromagnetically with a stator 10 mounted between the rails 18 of the wheel railway track, in particular supported on the sleepers 19.

As best illustrated in FIG. 4, the stator 10 may advantageously comprise a ballast support member 25 mounted securely on the sleepers 19 and an electromagnetic drive 22 that includes typically an electromagnetic coil mounted in a ferromagnetic armature or core.

The mover preferably comprises a permanent magnet unit 26 with magnetic segments of changing polarity arranged in the longitudinal direction (the direction of propulsion).

The electromagnetic drive with the coil of the stator and the permanent magnets of the mover couple electromagnetically to provide a propulsion force in the propulsion direction parallel to the rails 18 of the railway track. Linear motor systems are per se well known in railway systems and may have various configurations of coils and permanent magnets per se known in the art of linear motors.

In this regard, instead of a permanent magnet unit 26, the mover 11 may also be provided with a ferromagnetic unit that electromagnetically couples with the field generated by the coil on the stator to generate a force by induction, such systems also being per se known.

The mover may advantageously be coupled to the underside of the bogie 14 or chassis 15 via a mover coupling mechanism 12 that includes a height adjustment mechanism 20. The height adjustment mechanism 20 allows to adjust the airgap between the mover 11 and the stator 10. The adjustment may be dynamic, adjusting the airgap continuously as the railway vehicle moves along the railway track whereby sensors such as optical sensors or other proximity sensors may be provided to measure the airgap as the vehicle displaces, the sensors connected to a control loop of the control system to adjust the airgap within a defined range.

The height adjustment mechanism 20 may be used alternatively or in addition for raising the mover 11 over certain sections of track where the mover interferes with existing infrastructure components, for instance ferromagnetic parts that would interact in an adverse manner with the magnetic field of the mover permanent magnet unit, or with obstacles between the rails 18 that have a height that would interfere with the driving position of the mover. On such sections, the mover of the linear motor may be raised to clear such obstacles or when the section of railway track does not contain a stator and the locomotive is propelled only by the wheel rotation drive 5.

The mover coupling mechanism 12 may further comprise a propulsion direction adjustment mechanism 31 allowing for adjustment of the position of the mover in the propulsion direction (the longitudinal direction). This adjustment is useful in embodiments where a train set comprises a plurality of vehicles linked together with linear electrical motors such that the position of the permanent magnet unit relative to the stator coils of said plurality of linear electrical motors is adjusted correctly. In effect, since the stator coils are in fixed relative positions, and the position between two carriages is fixed once the vehicles are linked together in a train set, the movers need to be adjusted with respect to each other in order to have the correct phase engagement with the coil segments of the stator.

The height adjustment mechanism 20 of the mover coupling mechanism 12 may advantageously comprise an actuator 27 and a slide 28 engaging a complementary slide fixed to the bogie 14 or chassis 15 whereby the actuator in a preferred embodiment is in the form of a linear ball screw actuator. The slides 28 may also advantageously be in the form of ball or roller bearing slides to enable low friction displacement and rapid dynamic adjustment of the height of the mover 11 if required.

The propulsion direction adjustment mechanism 21 may also comprise an actuator 29 and a slide mechanism between a base part 43 and a moving magent support part 44 carrying the permanent magnet unit 26. The actuator may also comprise advantageously a linear ball screw actuator and the slides may also be provided with a linear ball or roller bearing slide.

In variants, the slides may however comprise lubricated slides without ball or roller bearings.

In variants, the actuator may comprise a pneumatic or hydraulic actuator or other per se known displacement mechanisms.

The stator 10 may advantageously comprise a coupling mechanism 23 that interconnects the electromagnetic drive 22 of the stator to the ballast support member 25 that is securely fixed to the sleepers 19 or securely fixed to a ballast or ground portion situated between the rails 18 (not necessarily fixed to the sleepers). The coupling mechanism 23 advantageously comprises a height adjustment mechanism 24, for instance a threaded bolt mechanism where the bolt can be turned to adjust the height of the stator electromagnetic drive. This allows to compensate for tolerances in the height of the sleepers relative to the railway tracks, for instance for sleepers with different constructions, to ensure that the stator electromagnetic drive has a height that is adjusted accurately with respect to a top of the rails 18. The rails define a height of the wheels on the railway track and thus the chassis 15 and mover 11 with respect to the railway track.

The propulsion system 4 according to embodiments of the invention comprises a motor control system 7 including an electric control unit 32 and a wheel rotation sensor or encoder 33 coupled to at least one of the wheels 16 of the railway vehicle.

The motor control system 7 may further comprise a wireless communications system including an antenna 34 mounted on the vehicle.

The wheel rotation sensor 33 measures the speed of the railway vehicle and is connected to the control of the linear motor in order to control the propulsion power of the linear motor that is dependent on the speed of the vehicle. This may be used for instance to provide the amount of supplementary power generated by the linear electric motor required to maintain a constant velocity when the railway vehicle is ascending a slope.

In embodiments of the invention, the railway track may be provided with a stator on certain sections of the railway track, in particular on the inclined portions so as to provide booster power to the propulsion system for vehicles engaging the ascending slope.

Track side markers may be present that are picked up by the electronic control system via the vehicle antenna in order to initiate the linear electric motor and prepare for switching on of the linear motor in order to maintain a constant speed of the vehicle.

It may be noted that the linear electric motor may also be used to brake the railway vehicle and recover electrical energy during the braking.

The track side position markers may also be used to signal to the vehicle sections of track that allow for higher speed or on the contrary that require lower speed travel or braking of the vehicle by control of the propulsion power produced by the linear electric motor.

The linear electric motor 6 may advantageously also be configured to locate the position of the railway vehicle on the railway track and to convert this location information into a standard transmission used by other railway vehicles employing the same track, for instance a standard transponder code, in order to signal the position of the railway vehicle to other vehicles in the railway infrastructure.

As such, on existing railway infrastructure it is known to provide markets such as the Eurobalise standard that signal the position of a railway vehicle that passes the Eurobalise 45 and that transmits this information to other railway infrastructure installations and other railway vehicles. In conventional systems, coordination of operations between railway vehicles is typically done with a vehicle-to-vehicle system or alternatively with a vehicle to infrastructure system. In embodiments of the present invention, both the vehicle-to-vehicle and vehicle to infrastructure communications systems may be employed whereby the linear motor advantageously allows to measure the location of the railway vehicle without requiring any specific markers on the railway track, thus allowing simultaneous vehicle-to-vehicle and vehicle to infrastructure communication and coordination without additional markers or sensors provided on the railway tracks. This allows for instance driving a platoon of vehicles along a railway track and to have the platoon vehicles to stop in the case of an emergency by an infrastructure to vehicle communication in addition to a vehicle-to-vehicle communication.

According to an embodiment of the invention, the linear motor allows measurement of the position of railway vehicles along any portion of the track without requiring any specific markers and a platoon of vehicles can thus be driven with both vehicle to infrastructure and vehicle-to-vehicle communication without additional railway track markers. In such configurations, one of the vehicles may be the master vehicle and other vehicles may be slave vehicles that follow the master vehicle, however in the case of an emergency situation, they may be each controlled by the infrastructure to vehicle communication for a safer and more reliable emergency behavior compared to a purely vehicle-to-vehicle system. In a variant, the master controller may be on the railway track infrastructure and the railway vehicles are driven as slaves.

The linear motor according to embodiments of this invention may be mounted on the underside of shunting vehicles that are used in a shunting yard for automated displacement between different loading/unloading positions using the coupling with the linear motor that determines both the location and velocity of the shunting vehicle. More easily automated control of the shunting vehicles between loading/unloading positions can thus be managed using a linear electric motor system retrofitted on a conventional shunting vehicle or conventional shunting yard of a railway infrastructure.

Existing infrastructure may be updated to incorporate railway vehicles with the retrofitted linear electrical motor or new rolling stock vehicles fitted with the linear electric motor according to embodiments of the invention whereby ferromagnetic components on the railway track such as the guardrail 39, closure rails 40, frogs (toe and heel) 41 and the switch rods 38a, 38b of a switch mechanism 37 that typically comprise ferromagnetic components may be replaced with non-magnetic materials, in particular non-magnetic metal alloys such as Hadfield steel.

### LIST OF REFERENCES

Cargo container 100

Railway system 1
Wheel railway track 3
   Rails 18
      Switch mechanism 37
         Switch rods 38a, 38b
      Guard rails 39
      Closure rails 40
      Frog (toe and heel) 41
   Sleeper Traverse 19
   Vehicle sensor 42
Wheel railway vehicle 2
   Carriage 13
   Bogie 14
      Platform 15
      Wheel 16
      Suspension 17
   Propulsion system 4
      Wheel rotation drive 5
         Rotary electric motor
         Catenary & pantograph system
         Diesel motor
      Linear electric motor 6
         stator 10
         electromagnetic drive (ferromagnetic core & coil) 22
         coupling mechanism 23
         adjustment mechanism 24
         ballast support member 25
         mover 11
         permanent magnet unit 26
         mover coupling mechanism 12
         base part 43
         magnet support part 44
         height adjustment mechanism 20
         actuator 27
         linear ball screw actuator
         slide 28
         ball/roller bearing slide
         propulsion direction adjustment mechanism 21
         actuator 29
         linear ball screw actuator
         slide 30
         ball/roller bearing slide
   Motor control system 7
      Electronic control unit 32
      Wheel rotation sensor (encoder) 33
   Wireless communication system 8
      Vehicle antenna 34

Vehicle tracking system 9
GSM communication unit 35
   Eurobalise 37
Trackside antenna 36

1.-27. (canceled)

28. Railway system with a railway infrastructure including a wheel railway track and wheel railway vehicles driven on the wheel railway track, the wheel railway track including rails mounted on a ballasted or unballasted ground support, for instance provided with sleepers, the wheel railway vehicles comprising a chassis, wheels coupled to the chassis, and a propulsion system including a linear electric motor and a motor control system including an electronic control unit, the linear electric motor comprising a mover mounted on an underside of the chassis, or mounted on an underside of one or more bogies comprising said wheels, and a stator comprising an electromagnetic drive mounted along at least a section of the wheel railway track between the rails of the wheel railway track, the mover comprisi a permanent magnet unit, characterized in that mover comprises a coupling mechanism including a propulsion direction adjustment mechanism configured to adjust a position of the permanent magnet unit with respect to the chassis or bogie in a direction of propulsion of the vehicle.

29. The railway system according to claim 28, wherein at least one of the wheel railway vehicles is a railway locomotive comprising a dual propulsion system, including the linear electric motor and a wheel rotation drive coupled via a transmission to at least one pair of the wheels of the railway vehicle.

30. The railway system according to claim 29, wherein the linear electric motor is configured as an auxiliary power unit that supplements the power provided by the wheel rotation drive, for instance during acceleration of the railway vehicle or to maintain a constant speed when ascending an inclined section of railway track.

31. The railway system according to claim 28, wherein the mover coupling mechanism includes a height adjustment mechanism configured to adjust a height of the permanent magnet unit with respect to the chassis or bogie so as to adjust an airgap between the permanent magnet unit and the electromagnetic drive of the stator.

32. The railway system according to claim 31, wherein the height adjustment mechanism of the mover coupling mechanism comprises an actuator and a slide, the actuator including a linear ball screw actuator.

33. The railway system according to claim 32, wherein the slide comprises a ball or roller bearing slide.

34. The railway system according to claim 28, wherein the propulsion direction adjustment mechanism of the mover coupling mechanism comprises an actuator and a slide, the actuator including a linear ball screw actuator.

35. The railway system according to claim 34, wherein the slide comprises a ball or roller bearing slide.

36. The railway system according to claim 28, wherein the propulsion system comprises a wheel rotation sensor coupled to the wheels to measure a speed of the rotation of the wheel, the motor control system further comprising a wireless communication system including a vehicle antenna configured to communicate wirelessly to external control systems coupled to track side antennas.

37. The railway system according to claim 28, wherein the linear electric motor measures a position of the vehicle along the stator and the motor control system comprises a module translating the position information into a standard transponder code.

38. The railway system according to claim 28, wherein the stator of the linear electric motor comprises a coupling mechanism interconnecting the electromagnetic drive to a ballast support member, the coupling mechanism having a height adjustment mechanism configured to adjust the height of the electromagnetic drive with respect to the rails on the railway track.

39. The railway system according to claim 28, wherein a switch mechanism of the railway system comprises switch rods, guardrails and closure rails of non-ferromagnetic alloys.

40. The railway system according to claim 28, wherein the motor control system comprises a communication system configured to perform both vehicle-to-vehicle and vehicle to infrastructure.

41. The railway system according to claim 28, wherein the communications system and control system allow a plurality of vehicles to be driven in a platoon formation where the position of the vehicles is provided by the coupling of the movers to the stator for each vehicle.

42. Railway system with a railway infrastructure including a wheel railway track and wheel railway vehicles driven on the wheel railway track, the wheel railway track including rails mounted on a ballasted or unballasted ground support, for instance provided with sleepers, the wheel railway vehicles comprising a chassis, wheels coupled to the chassis, and a propulsion system including a linear electric motor, the linear electric motor comprising a mover mounted on an underside of the chassis, or mounted on an underside of one or more bogies comprising said wheels, and a stator comprising an electromagnetic drive mounted along at least a section of the wheel railway track between the rails of the wheel railway track, wherein the propulsion system comprises a motor control system including an electronic control unit and a wheel rotation sensor coupled to the wheels to measure a speed of the rotation of the wheel, the motor control system further comprising a wireless communication system including a vehicle antenna configured to communicate wirelessly to external control systems coupled to track side antennas, and wherein the communications system and control system allow a plurality of vehicles to be driven in a platoon formation where the position of the vehicles is provided by the coupling of the movers to the stator for each vehicle.

43. The railway system according to claim 42, wherein at least one of the wheel railway vehicles is a railway locomotive comprising a dual propulsion system, including the linear electric motor and a wheel rotation drive coupled via a transmission to at least one pair of the wheels of the railway vehicle.

44. The railway system according to claim 43, wherein the linear electric motor is configured as an auxiliary power unit that supplements the power provided by the wheel rotation drive, for instance during acceleration of the railway vehicle or to maintain a constant speed when ascending an inclined section of railway track.

45. The railway system according to claim 42, wherein, the mover comprises a permanent magnet unit and a coupling mechanism including a propulsion direction adjustment mechanism configured to adjust a position of the permanent magnet unit with respect to the chassis or bogie in a direction of propulsion of the vehicle.

46. The railway system according to claim 45, wherein the mover coupling mechanism includes a height adjustment mechanism configured to adjust a height of the permanent magnet unit with respect to the chassis or bogie so as to adjust an airgap between the permanent magnet unit and the electromagnetic drive of the stator.

47. The railway system according to claim 46, wherein the height adjustment mechanism of the mover coupling mechanism comprises an actuator and a slide, the actuator including a linear ball screw actuator.

48. The railway system according to claim 47, wherein the slide comprises a ball or roller bearing slide.

49. The railway system according to claim 45, wherein the propulsion direction adjustment mechanism of the mover coupling mechanism comprises an actuator and a slide, the actuator including a linear ball screw actuator.

50. The railway system according to claim 49, wherein the slide comprises a ball or roller bearing slide.

51. The railway system according to claim 42, wherein the linear electric motor measures a position of the vehicle along the stator and the motor control system comprises a module translating the position information into a standard transponder code.

52. The railway system according to claim 42, wherein the stator of the linear electric motor comprises a coupling mechanism interconnecting the electromagnetic drive to a ballast support member, the coupling mechanism having a height adjustment mechanism configured to adjust the height of the electromagnetic drive with respect to the rails on the railway track.

53. The railway system according to claim 42, wherein a switch mechanism of the railway system comprises switch rods, guardrails and closure rails of non-ferromagnetic alloys.

54. The railway system according to claim 42, wherein the motor control system comprises a communication system configured to perform both vehicle-to-vehicle and vehicle to infrastructure.
